(19) United States
(12) Patent Application Publication
(10) Pub. No.: US 2012/0052467 A1
(43) Pub. Date: Mar. 1, 2012

(54) ONLINE LANGUAGE TRAINING SYSTEM

(75) Inventors: Don W. MAYBIN, Atami-shi (JP); Kurt VANVOLKENBURGH, Marugame-shi (JP); Lihua YE, Tokyo (JP)

(73) Assignee: SULANTRA LIMITED, Hong Kong (HK)

(21) Appl. No.: 12/868,609

(22) Filed: Aug. 25, 2010

(51) Int. Cl. G09B 19/06

(52) U.S. Cl. 434/157

(57) ABSTRACT

An online foreign language training system is disclosed for providing a rapid introduction to a foreign language. Language instruction may be provided from a matrix of target languages and user languages, such that a single site may serve as a teaching system for teaching many different foreign languages and thus provide individuals with the ability to learn many different languages using the same user interface. Language curriculum may be customized based on user selections and user demographics to improve the relevance of the instruction to a user in terms of its length, thematic functions, and types of graphical images and sounds presented to the user. Language instruction is presented in a spiraling format in which different thematic themes are presented at each level and the complexity increases at increasing levels of instruction. The online language training system also uses icons to contextually introduce key terms for “controlling” communication, or conversation management. The user interface is simple and easy to use.

### FIELD OF THE INVENTION

The present invention is related to online language training. More particularly, the present invention is directed to a highly efficient, effective, and low cost means to provide a user with a rapid introduction to a foreign language.

### BACKGROUND OF THE INVENTION

There are numerous products available in both software and online websites for language study. A problem with current methods of language study is that most language training software or websites have disadvantages such as high costs, requiring an inordinate amount of study time, or producing limited results.

One special type of foreign language training is rapid introduction to a foreign language in a very limited amount of time, e.g., ten to thirty hours of time. For example, a few weeks before a business or pleasure trip, someone may want a short crash course prior to departure. Learning must therefore be extraordinarily rapid, efficient, and effective in terms of retention. There are highly efficient techniques to introduce people to a foreign language in conventional classroom settings. This includes the Action-Based Language Empowerment (“ABLE”) teaching method developed by the inventor of the present patent application to provide a short, intensive introduction to a target language. The ABLE teaching method permits a human teacher to provide an extremely rapid introduction to a foreign language for a small group of students in a classroom setting. However, these classroom techniques rely upon the skill of human teachers to interact face-to-face with their students in a small group setting. There do not appear to be any online services in the prior art that are capable of replicating the rapid foreign language teaching techniques used by human teachers applying the ABLE teaching method. Moreover, there are technical barriers to replicate in software a classroom experience in which a teacher actively monitors the progress of their students and adapts their teaching style.

Therefore, there is a need for an improved language training system, method, and computer program product.

### SUMMARY OF THE INVENTION

An online language training system permits a language learning site to provide foreign language instruction to a user via a client device, such as a personal computer or a cell phone. The foreign language instruction may be directed to providing a rapid introduction to a foreign language.

One aspect of the present invention is a method and system for providing on-line foreign language instruction in a spiralling format in which a set of thematic functions are presented at each level and the instruction increases in complexity at higher levels. Additionally, content is recycled and reviewed in a more complex fashion at higher levels.

Another aspect of the present invention is an improved user interface. In one implementation, the user interface presents no more than six different language items at a time on the user interface. Each language item includes an ideograph, such as a simple picture representing a word or phrase. Each ideograph has an associated audio segment in the target language. A user inputs a selection that corresponds to a selected ideograph, such as by using a computer mouse to point and click on an ideograph or tapping on the ideograph via a touch screen. In one implementation, the user does not input any audio inputs. An ideograph may be highlighted to indicate its association with a word or phrase during an introduction or training phase. Additional testing phases are provided to test the user about the language items. Rules are provided for generation of questions, the removal of questions from question pools in response to correct answers, scoring a user, and advancing the course based on the user's scores.

Yet another aspect of the present invention is tailoring the curriculum for an individual user. Different versions of the curriculum for a target language are stored on a language provider site. The different versions may include different versions for different ages, genders, intended travel destinations (e.g. British vs. American English), or other demographic groups. Additionally, users may select different versions such as a starter course, basic course, and expanded course where the amount of content in each level and the number of levels is varied to adjust the length of time required for each type of course. Moreover, while in one embodiment certain mandatory thematic functions are included, additional elective thematic functions may also be selected by a user. The ability to tailor the curriculum to the user provides numerous advantages over the prior art.

One more aspect of the present invention is that a language provider site may serve as site to provide many different foreign languages. In particular, a matrix of different foreign languages may be supported in which a user selects their (native) user language and a target language from a matrix of languages. Once a user is familiar with the user interface, they may then easily use the same user interface to learn other languages in the matrix.

### BRIEF DESCRIPTION OF THE DRAWINGS

An embodiment of the invention will now be described in detail, by way of example only, and with reference to the accompanying drawings, in which:

FIG. 1 shows an application structure in accordance with one embodiment of the present invention;

FIG. 2 shows a standard, “columnar” teaching approach in accordance with the prior art;

FIG. 3 shows the “horizontal” format of curriculum in accordance with an embodiment of the present invention;

FIG. 4 shows the curriculum “spiral” through 4 functions and 6 levels in accordance with an embodiment of the present invention;

FIG. 5 shows the matrix or “mesh” arrangement of User and Target languages in accordance with an embodiment of the present invention;

FIG. 6 shows the course structure of Language, Course, Function, Level and Sub-module in accordance with an embodiment of the present invention.

FIG. 7 shows the course structure of Level, Sub-module and Item in accordance with an embodiment of the present invention.

FIG. 8 shows the data structure of the system in accordance with an embodiment of the present invention.

FIG. 9 shows the core of the site in accordance with an embodiment of the present invention.

FIG. 10 shows a screen shot of a Course Page in accordance with an embodiment of the present invention.

FIG. 11 shows a user-interface screen shot of a learning display in accordance with an embodiment of the present invention illustrating the presentation of a set of language item ideographs and other information.

FIG. 12 shows a process flow chart illustrating the operation of an introductory stage of a sub-module in accordance with an embodiment of the present invention.

FIG. 13 shows a process flow chart illustrating the operation of a consolidate stage of a sub-module in accordance with an embodiment of the present invention.

FIG. 14 shows a process flow chart illustrating the operation of an expansion stage of a sub-module in accordance with an embodiment of the present invention.

FIG. 15 shows a process flow chart illustrating the operation of an education stage of a sub-module in accordance with an embodiment of the present invention.

FIG. 16 shows a process flow chart illustrating the operation of a challenge phase of a sub-module in accordance with one embodiment of the present invention.

FIG. 17 shows a high-level functional block diagram illustrating aspects of the present invention regarding the generation of a customized curriculum and the presentation of a target language in spiralling format.

FIG. 18 is a screenshot teaching the meaning of language assistance icons.

FIGS. 19-21 illustrate exemplary progression tables for the progress of curriculum at different levels of instruction.

FIGS. 22-24 illustrate examples of how a language item for the word “Beijing” is formed into more complex phrases.

### DETAILED DESCRIPTION OF PREFERRED EMBODIMENTS

The present invention is directed to an improved computer implemented system, method, and computer program product for learning a foreign language. An exemplary application of the present invention is an online system for a short, intensive introduction to a target foreign language in a limited amount of time, such as 12 hours of study time for the starter course, or 30 hours of study time for the basic course.

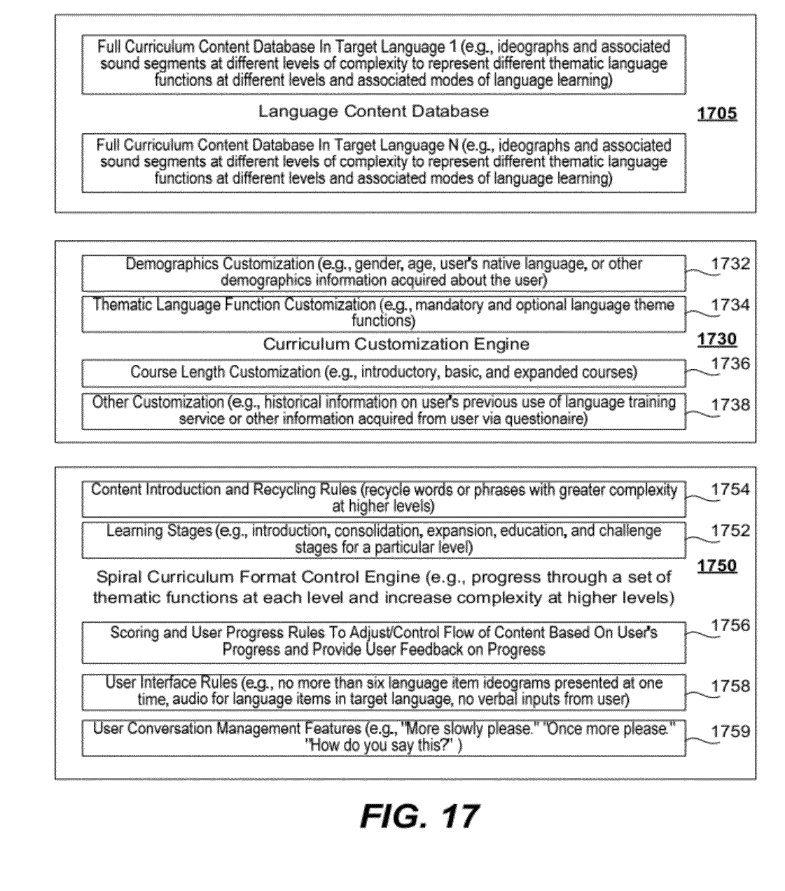

FIG. 17 is a block diagram illustrating, at a high block level of abstraction, some of the functional modules of the present invention as an introduction to an online language learning system. The modules illustrated in FIG. 17 may be implemented in software and stored on a computer readable storage medium at a server site of a language provider for an online implementation to provide language instructions to users via client devices, such as personal computers and cell phones.

A database 1705 includes content for a set of target languages 1 to N, where N is a positive integer number to illustrate that a set of different target languages may be supported. Each target language has associated with it a “full” set of curriculum in terms of content for language ideographs and associated audio content in the target language for an introduction to a target foreign language.

One aspect of the present invention is a curriculum customization module/engine 1730 to tailor a course for a user. Tailoring a course to the goals and attributes of the user improves learning efficiency. A demographics module 1732 customizes based on demographic information about the user, such as the user's gender, age, native language, or other types of information that are acquired about the user via a questionnaire or other sources. A thematic customization module 1734 customizes the number of thematic language functions that will be learned, such as permitting a user to select thematic options. In one embodiment, a user selects optional thematic functions and there are additional mandatory thematic functions. However, more generally all of the thematic options may be optional, to modify the set of thematic language functions that will be learned based on the user's interests and goals. A course length customization module 1736 permits the length of the course (in terms of amount of number of items presented for learning) to be customized into different course lengths, such as a starter course, a basic course, and an expanded course. Other types of customization may also be performed via module 1738, such as using historical information on the user's previous use of the language training service as an additional factor or taking into account additional user preferences.

As described below in more detail, a spiral curriculum format control module/engine 1750 provides the tailored curriculum in a format designed to achieve rapid learning. In a spiral format there is a set of different levels. In each level, curriculum for a set of thematic functions is presented and the curriculum increases in complexity at higher levels. Within an individual level, there are preferably different learning stages 1752, such as an introduction stage, consolidation stage, expansion stage, education stage, and a challenge stage. Rules are provided 1754 for content introduction and recycling. Scoring and progress rules 1756 are supported to provide feedback to a user on their progress and to adjust the flow of content. User interface rules 1758 are provided to present language items in a simple, intuitive user interface that is easy to use. In one implementation, the number of words/phrases presented for learning on the user interface at any one time is kept at or below some maximum number. User conversation management features 1759 may be supported to permit a user to control the learning environment and also master conversation management skills.

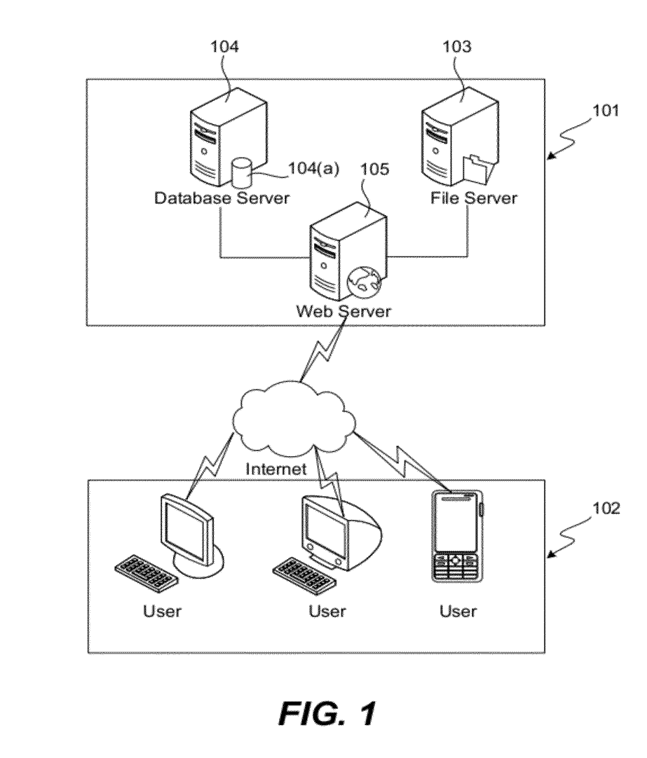

With reference to FIG. 1, there is shown a schematic block diagram of the hardware architecture of the system according to an embodiment of the invention. A server site 101 includes the hardware elements of the servers provided by a web hosting service. A client site 102 includes the hardware elements (client devices) of the users for whom online language training services are being provided. The hardware elements of the users and of the servers can communicate via the Internet.

The server site 101 includes a server or servers hosting the service, such as a file server 103, database server 104 and web server 105. The web server 105 hosts a number of software applications that support an online implementation of the invention. Two preferred web server applications are Apache™ Web server and Ruby on Rails®, which are both open source software applications. The web server 105 is a server delivering Web pages to clients and is in communication with the database 104(a), which includes a database server 104 hosting a database management system. A preferred database software is MySQL 5. The database 104(a) includes a number of tables having fields for storing a number of data items as will be described in greater detail below. The invention also has multimedia information, such as still images, sound data and animation. This requires extensive data storage which is associated with the file server 103.

The server site 101 also executes a high level application program (not shown) for implementing the service. This application program is stored on a non-transitory (non ephemeral) computer readable storage medium, such as on a memory associated with the file server 103. The file server 103 also includes one or more processors for executing the application program. The online language learning software application includes the software modules that implement the functionality of the modules, sub-modules, features, and control functionality of the online language learning system that are described below in more detail.

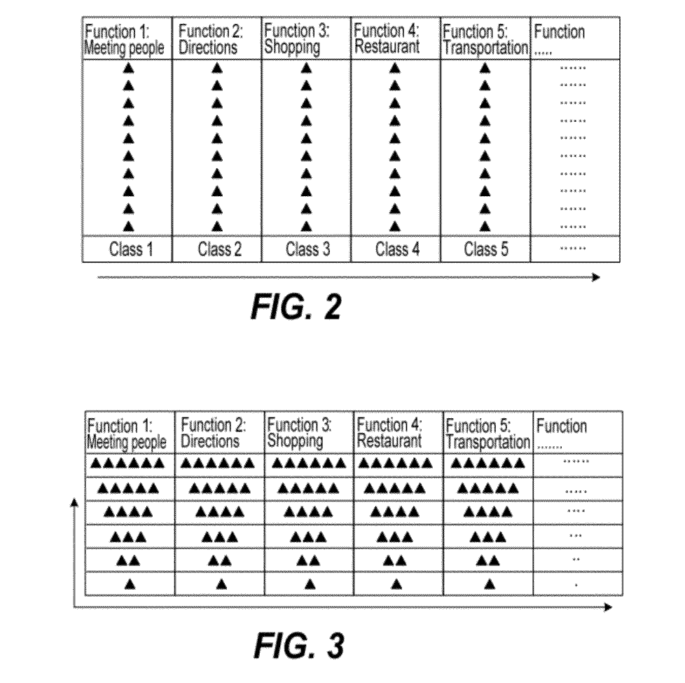

The format of a course has a unique spiralling format. For the purposes of comparison, a standard foreign language curriculum is illustrated in FIG. 2, which shows that there is one theme presented “vertically” in each lesson. Thus, for example, in the standard curriculum approach of FIG. 2, a single online class might focus on one theme, such as “meeting people” or “directions.” In contrast, FIG. 3 illustrates how in the invention, each thematic unit is divided into multiple levels. In an exemplary embodiment, the course includes six levels. At each level, there is cycling from one thematic function to the next function. After a user has successfully graduated from one level, they progress to the next level. The themes are cycled through at the next higher level but with a greater level of complexity.

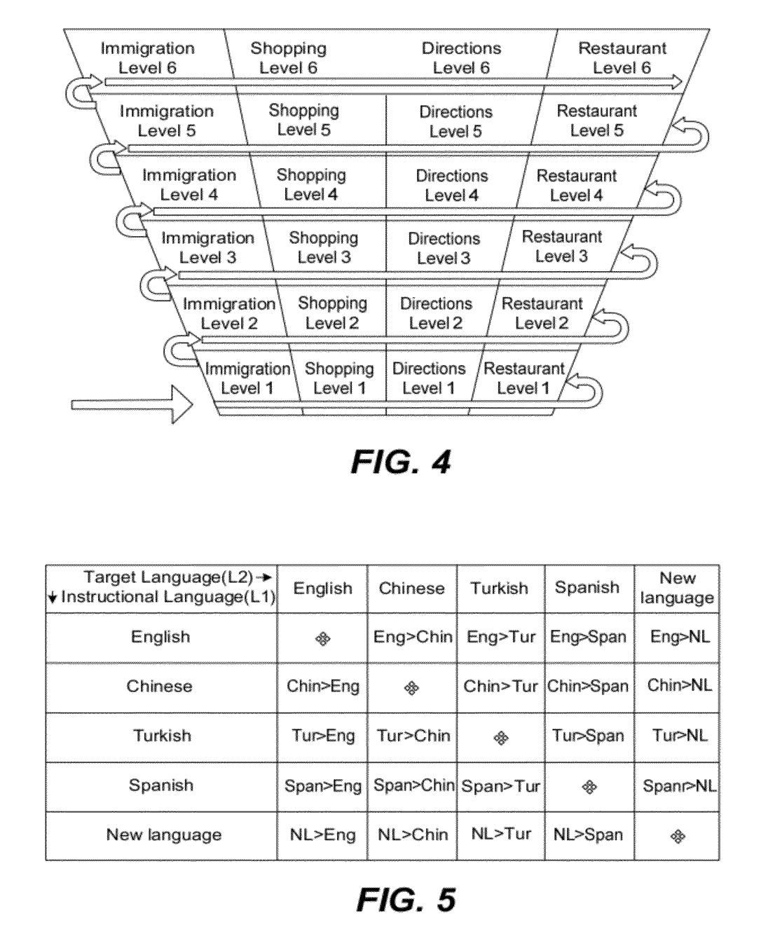

In the standard curriculum of FIG. 2, learners tend to forget earlier material as the course progresses. In the course of FIG. 3, the target language is reviewed and expanded. When the material for one module has been covered, users move “horizontally” to the module for the next thematic area. Once all thematic modules at one level have been covered, users progress to the next course level where material presented at the previous level is recycled and expanded. The end result is a spiralling format FIG. 4, which develops the user's ability to remember key language and retrieve it for application.

As previously described, one application of the present invention is to provide an extremely efficient, intensive introduction to a foreign language. Consequently, some users may desire to use the online service to be rapidly introduced to a new language prior to vacation trips or business trips. It is thus contemplated that some users, once they become familiar with the system, will return again to learn another language. Therefore it is desirable to support the ability of learners to learn many different languages. When a new language is added to the database, it is preferably entered as a user language, as well as a target language, as illustrated in FIG. 5. In particular, each new language has audio content in the new (target) language that is associated with the ideographs of individual language items. Some ideographs may be generically used for different target languages. Alternatively, customized ideographs may be stored for specific target languages. Additionally, each new (user) language may also have some (minimal) assistance information in each user's language, which is described below in more detail. Thus, much of the content (in terms of pictures and audio in a target language) may be used to support many different user languages. Conversely, much of the content in the user's language (e.g., assistance icons and text on user interfaces) may be used in a generic manner to support many different target languages. There are thus economies of scale in that a common database may be used to support different combinations of user languages and target languages.

Other study systems deal in a single user language with possibly a variety of target languages. With the online service of the present invention, there is a “mesh effect”—the user can go directly from his or her first language to study an ever-increasing number of target languages. Thus, as an illustrative example, a native speaker of English can use the system to study any other target language in the mesh database, such as Chinese, Turkish, Spanish, etc. Conversely, a native speaker of Chinese can also use the system to study any other language in the mesh database, such as English, Turkish, Spanish, etc. This approach has several advantages. First, it permits a language site to have economies of scale as a single “go to” site to find instruction in a wide variety of languages. Secondly, once a user is familiar with the user interface, it is easy to come back to the online service and learn another language.

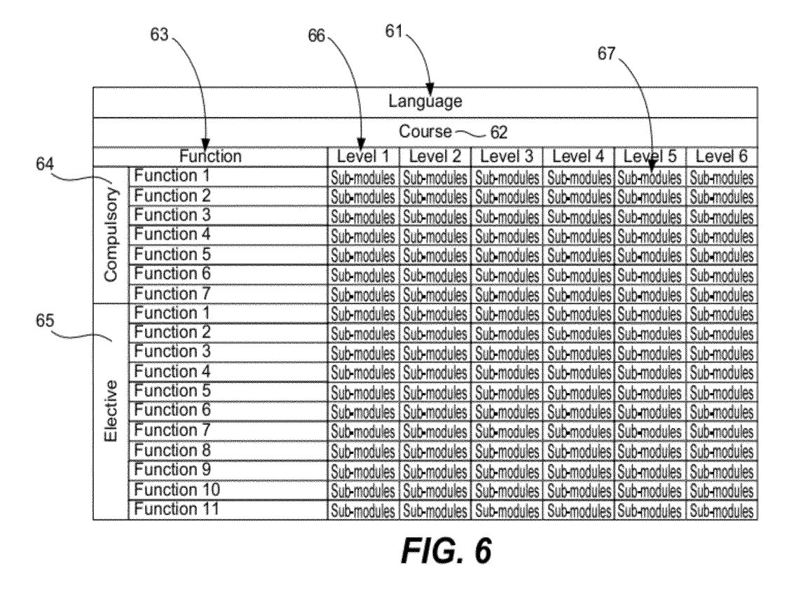

With reference to FIG. 6, there is shown a table of components in the system in accordance with one embodiment to illustrate aspects of the invention. The components are implemented in software and supported by corresponding databases.

Language 61 is the fundamental component of the system, which refers to the target language of the course being studied. For example, if the user desires to learn Spanish, then Spanish is the target language.

Course 62 is the learning program of a language. Each target language has different types of courses—such as Starter, Basic and Expanded—to match the desires of users. In one implementation, a Basic course is a shorter course than the Expanded course, which has up to three times more content. The ability to select different types of course helps to achieve psychological salience by matching the user's desire to the length of the course. The Starter course is directly integrated into the Basic course and the Basic course is directly integrated into the Expanded course in order to build confidence and motivate users to continue with their studies.

Function 63 displays the functional curriculum goals of the course. Upon registration the user has access to a pre-selected set of core thematic language functions and, in the case of the Basic and Expanded courses, can select from an additional optional set of thematic functions. This helps to achieve psychological salience in which the course is optimized for the goals of the user. That is, the user is introduced to only those curriculum themes that are likely to be useful and of interest to the user. In one implementation, the core and elective curriculum is highly focused on themes likely to be of interest to a user travelling abroad after a short session of study, as well as to merchants and service sector personnel who interact with tourists.

In one implementation, there are seven core functions of the curriculum. These seven core functions are referred to as the Compulsory curriculum functions 64.

In addition, in one implementation, a user can select any or all of the eleven Elective curriculum functions 65 based on the user's interests or perceived needs. The combination of Compulsory and selected Elective functions makes up the entire curriculum for the user's course.

An exemplary list of seven Compulsory curriculum functions 64 are:
Compulsory 1—Meeting People
Compulsory 2—Directions
Compulsory 3—Public Transportation—Local
Compulsory 4—Shopping
Compulsory 5—Ingredients
Compulsory 6—Restaurants
Compulsory 7—Entertainment

An exemplary list of eleven Elective curriculum functions 65 are:
Elective 1—At the Border
Elective 2—Problems & Safety
Elective 3—Accommodation
Elective 4—Public Transportation—Long Distance
Elective 5—Banking & Post Office
Elective 6—Homestay
Elective 7—Health (Doctor, Pharmacy & Dentist)
Elective 8—Personal Care
Elective 9—Rentals
Elective 10—Telephone
Elective 11—Script (Reading a Menu)

In the present invention, a course is presented horizontally by levels, such as 5 or 6 levels 66. Level 1 is the introductory level; Level 6 is the highest level. The Starter and Basic courses have 5 levels, while the Expanded course has 6 levels. Training for each functional thematic area is completed in Functional Modules. Once a level is completed, the user progresses to the next level.

The Functional Module in each level is divided into Sub-modules 67. A Sub-module is a group of items 68 in the same functional context. Each Sub-module is presented in 4 or 5 stages. Stage 5 is an optional Challenge Mode. Once the user has correctly identified all of the items in Stage 4 of a Sub-module (drawn from a pool of a maximum of 36 available items), the user moves horizontally to the next module (i.e. a different function), or to the optional Challenge Mode, Stage 5, of the same function.

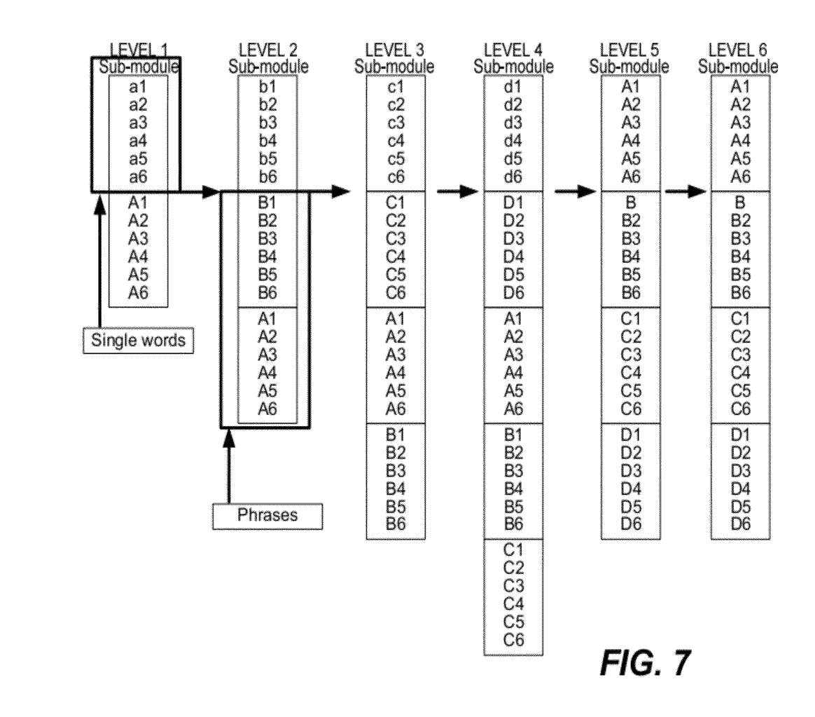

With reference to FIG. 7, the language under study in a stage is presented visually in groupings of up to 6 “language items” in Stages 1-2. A language item is an ideograph representing a word or phrase. As an example, a language item may include pictures, numbers, or symbols. Each language item has associated audio in the target language used to introduce the language item in an introduction phase, and also to prompt a response from the user in a question/test mode phase. Normally, these language items are introduced as single words which are embedded in phrases in Stages 3, 4 and 5. Some language items are phrases which are not embedded, but function independently. In FIG. 7, single words are indicated in lower case and phrases are indicated in upper case. A new letter at each level indicates new content (words or phrases). Thus, there is a progression in which single words are introduced at a particular stage and may be repeated at higher levels in phrases. The complexity (in terms of vocabulary and number of phrases) increases with each level.

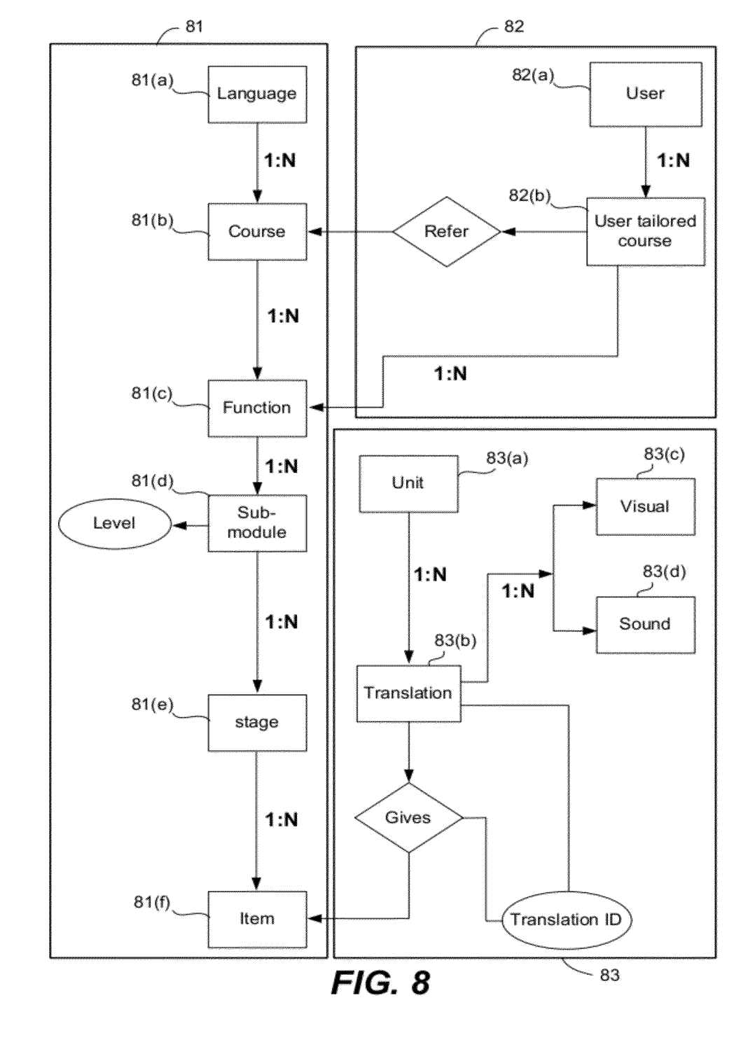

With reference to FIG. 8, there is shown a flow chart diagram illustrating aspects of the data structures of the key components in the system and their interactions with an end user.

Flow chart 81 includes the data objects of Language 81(a), Course 81(b), Function 81(c),

Sub-module 81(d), Stage 81(e), and Item 81(f). A language potentially has many different possible courses. A course has many functions. A thematic function has many sub-modules. A sub-module has many stages. Sub-module data also contains Level information. A stage has many items.

Flow chart 82 illustrates that a user 82(a) can input selections, using a user interface of a client device, to generate a user-tailored course 82(b). That is, for a particular target language, the system can store different versions of a limited curriculum that are then adapted to improve learning efficiency. For example, the user inputs may include the user's native language (user language) and the target language (language to be learned). The user's language determines how certain textual information, such as progress indications and assistance information, is presented. The user's language also provides a type of demographic information in that the user's native language may (in some cases) be relevant to content optimization in the target language based on similarities or dissimilarities to the target language or cultural factors that may affect the relevance of certain types of content to the user. Additionally, the user may also input other selections that customize the course for the user. As previously described, in one implementation a user can select different course lengths (e.g., a Starter, Basic or Expanded course) and also select elective functions on top of the compulsory functions. Additional customization may also be included, such as user-inputs designating the gender of the user, the age of the user, or other demographic factors that may be useful to generate a user-tailored course specific to the needs and background of the user, such as the user's intended travel destination (and hence likely to be interested in alternative versions of the target language, such as Quebecois French or Moroccan Arabic).

For example, different versions of the curriculum may be stored to support the user-tailored course, such as having age-appropriate content for at least two different age ranges. Age-appropriate content may be directed to the manner in which content is presented (e.g., an older sounding voice for an older user or more pictures of older people for older users). Age-appropriate content may also include customizing the specific content based on age and/or based on travel issues likely to be of interest to different age groups (e.g., displaying content related to the health needs of individuals based on age, such as presenting content related to dentures or glasses for senior citizens that are more likely to be concerned about such issues).

In the case of gender, the audio voice and the type of pictures may be based in part on gender. Additionally, in some target languages the language itself has extensive gender-based use of language, for example Thai, that may favor providing content based on the gender of the user in order to tailor the instruction to the needs of the user. Users identify their gender when they sign up and the program automatically lines up the study course to the user profile. For the first three levels of the course, the user will hear language modeled by speakers of his or her gender; from the fourth level, language is modeled by both genders.

While gender and age are two examples of demographic information, more generally other types of demographic information about a user may be requested from the user to tailor the curriculum for an individual user. In a preferred embodiment, a user is requested, via a user interface, to provide the demographic information. However, it will be understood that some types of demographic information may also optionally be acquired from services that provide demographic information for web-based transactions.

The system thus has user-related data, which are objects of the user's selected functions and tailored courses. In one implementation, a user may thus potentially have many different user tailored courses in his or her file set. A user tailored course has many functions.

The execution of a given customized course results in visual images and sound generated on a user interface. Additionally, a user inputs responses to specific items. Flow chart 83 includes script data, which are objects of Unit 83(a), Translation 83(b), Visual 83(d) and Sound 83(d). A unit has many translations. In particular, certain types of instructions, progress indications, user interface information, cultural details of the target language, and assistance information is presented in the user's native language and hence requires translation. Thus, a translation has at least visual information that is associated with a language item. Additionally, a translation may also have auditory information associated with a language item.

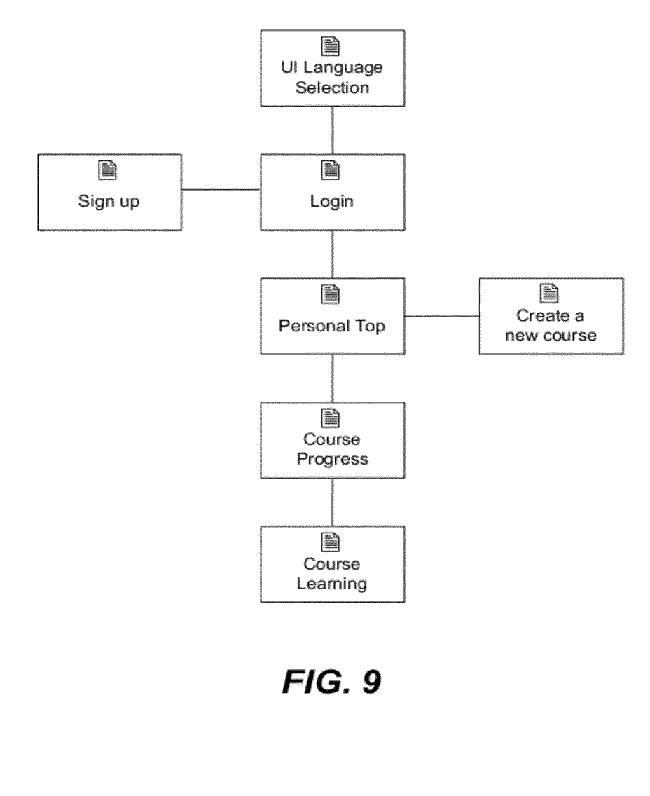

With reference to FIG. 9, there is shown a diagram of a website map in accordance with an embodiment of the invention. Before a user starts to use the site, they must choose a user language. Once the user language is selected, all information on the site (outside of instruction in the target language) is displayed in the chosen user language. That is, certain types of status information, progress information, cultural information, and assistance information is presented in the user's language while the principal language instruction itself is presented in the target language. The user interface language can be changed at any time.

If the user has an account, they can login to the site. If not, the user must sign up for a new account. A valid e-mail address, login username, age, gender information and password are required at sign up.

After login, the user will enter their personal Top Page. On the Top Page, the user's courses will be displayed.

The user can create a new course from his/her personal Top Page. There are three steps to creating a new course. Step 1 is to choose a language. Step 2 is to choose the Starter, Basic or Expanded course. Step 3 is to choose elective functions as desired for the Basic or Expanded courses.

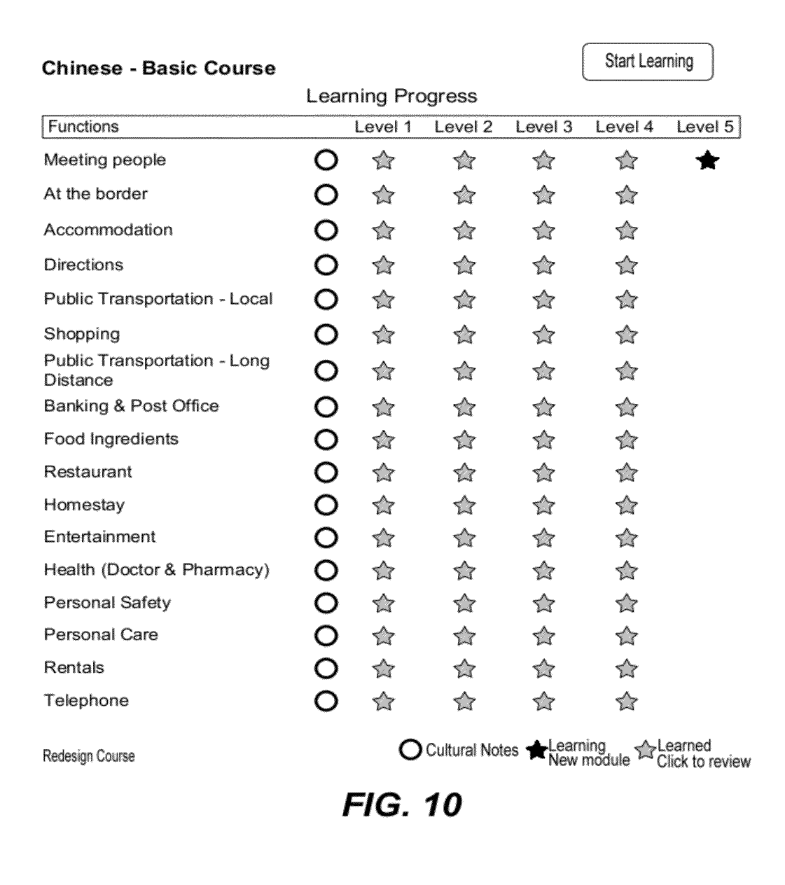

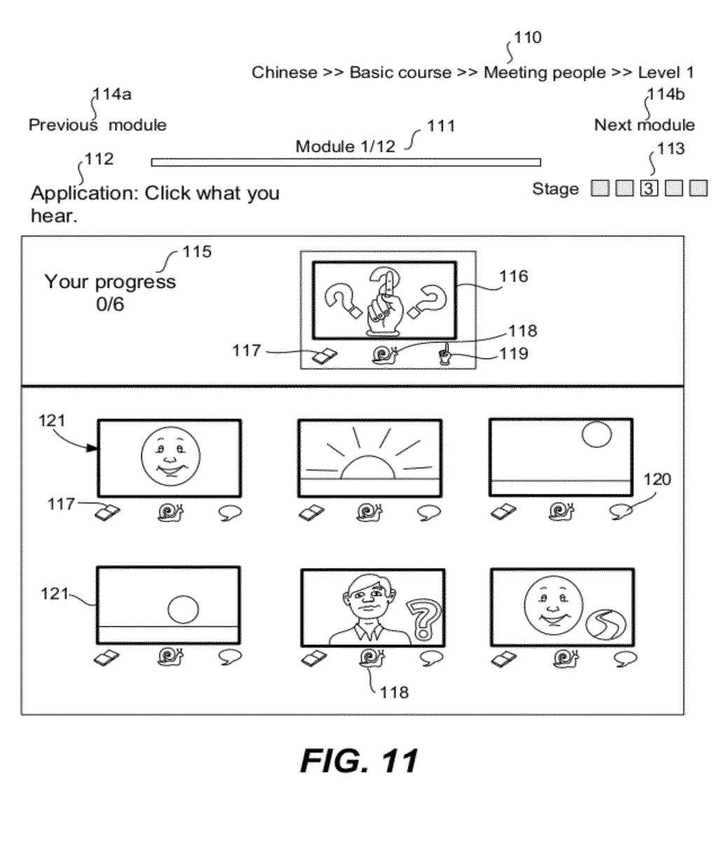

From the user's personal Top Page, the user can access the Progress Page (see FIG. 10) for any language under study by the user to check the course's progress. The Progress page indicates what thematic functions and levels the user has completed. This feedback is useful since the recommendations is for a user to study in 60 to 90 minute sessions and return back at a later time (e.g., the next day) for another session. From the Progress Page, the User can access a Course Learning Page (see FIG. 11).

With reference to FIG. 11, there is shown a screen capture of a learning interface in accordance with one embodiment. A course navigation bar is displayed at the top and shows the language being studied, Course, Function and Level. A Module bar 111 shows the sub-module being studied and the total number of sub-modules in the Function at the Level. A purpose title and a short instruction 112 for the current stage (related to the learning/test mode and what the user is expected to do in response to audio outputs in the target language) is located under the Module bar. In this example, the short instruction 112 instructs the user to choose the language item 121 corresponding to the audio that they hear in the target language. Note that this short instruction 112 is presented in the user's native language. The amount of assistance presented in the user's native language is kept comparatively small and given only in written form to avoid aural interference and to promote efficient learning of the target language.

The Stage bar 113 consists of five small boxes which represent the five stages of the sub-module. In one color-coding scheme, the Current Stage is highlighted in white. Completed stages are in light orange. Enables stages are in green. Some modules do not have Stages 1, 2 or 3; disabled stages are in grey. Once a stage is completed, the system automatically advances the user to the next stage.

In the Module Controller, there are two icons. On the left: Icon 114a is used to return the user to the previous sub-module; Icon 114b is used to advance the user to the next sub-module.

If the Current Sub-module is not the first sub-module in that function and level, Icon 114a is enabled.

If Stages 1, 2, 3, and 4 have been learned, Icon 114b is enabled.

A Progress Box 115 is displayed if the Current Stage is Stage 3, 4 or 5. The user must select a sufficient number of correct answers to finish that stage. The number (maximum 36) of required correct answers is based on the number of items in that stage.

Question/Statement 116 is a visual over three icons. A Question/Statement can be a randomly selected phrase or a randomly-generated statement, which may be framed in a “mini conversation”. In a preferred embodiment, audio for the Question/Statement is in the target language.

Icons 117, 118, 119 and 120 are Learning Assistance Icons with “icon language”. “Icon language” is key target language orally presented after the icon is clicked and before the “Effect” is provided. The learning assistance icons include conversation management assistance including providing conversation management phrases in the target language that are useful for managing conversation. Research by the inventor indicates that mastery of conversation management words and phrases (e.g., “What does that mean?” “Once more, please” “More slowly, please” “How do you say this?”) are extremely important in an introductory foreign language course. The conversation management features are useful to facilitate the learning process. Moreover, the mastery of conversation management words and phrases it an important skill when the user applies the foreign language in a real-world situation.

The Icon Language for Icon 117 is “What does that mean?” After the icon is clicked, a textbox pops out from the icon. A written translation in the user's language for the item in question appears in the textbox. In Stages 1 and 2, there is no audio component. In Stages 3, 4 and 5, the question “What does that mean?” is given an audio presentation in the target language.

The Icon Language for Icon 118 is “More slowly, please.” Once the “More slowly, please.” icon is clicked for any item displayed, the Icon Language is given an audio presentation at regular speed followed by the selected item's language presented at a slower speed.

The Icon Language for Icon 119 is “Once more, please.” Once the “Once more, please.” icon is clicked for any item displayed, the Icon Language is given an audio presentation followed by an audio presentation of the selected item's language.

The Icon Language for Icon 120 is “How do you say this?” Once the “How do you say this?” icon is clicked for any item displayed, the Icon Language is given an audio presentation followed by an audio presentation of the selected item in the target language.

The total number of language items 121 presented at one time for learning or testing should be limited to a maximum number that optimizes learning and memory retention. It is preferable to present no more than six language items 121 at any one time. In one implementation, a maximum of six language items 121 are displayed below the Question/Statement. Each individual language item 121 is an icon that has a visual presented with a border 122 that in one implementation includes three language assistance icons. Each individual language item 121 is an ideogram for a particular word or phrase of a thematic function. As one example, an ideograph having a picture of a clock may be used to indicate time (e.g., hours) while a picture of the sun can be used to represent a day. Numbers may also be included in ideographs.

The user hears a phrase and selects an answer from the displayed language items 121. If the answer is correct, one point will be added to the Score Box 115. If the answer is incorrect, the correct answer is highlighted and the user is automatically advanced to the next question.

In one implementation there is an initial introductory training period in which the user hears the word of phrase and the border 122 for the corresponding item 121 is highlighted. For example, a training sequence may have the word/phrase for each item repeated and the corresponding border 122 highlighted. In one implementation the training session verifies that a user has formed an association between the item and the word/phrase by requiring them to click on the items in Stages 3, 4, and 5 after hearing the corresponding word/phrase for the icon.

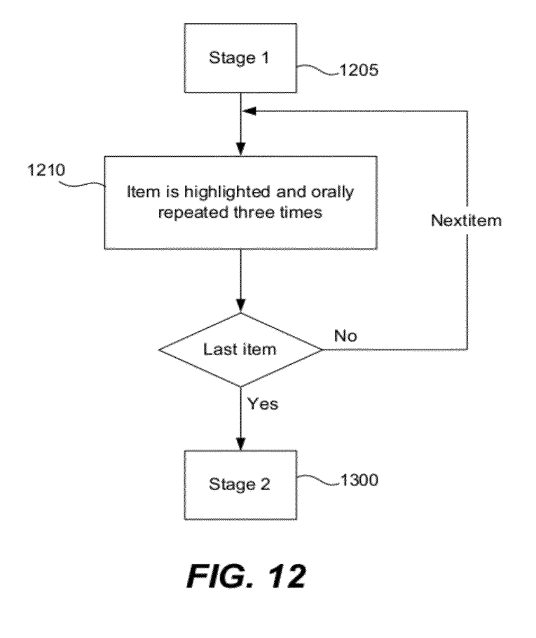

An overview of the process of Stage 1 is illustrated by the flowchart of FIG. 12. Stage 1 is the Introduction Stage 1205. In Stage 1, the language items are introduced sequentially in step 1210 with each item highlighted and given an audio presentation with the audio for the word or the phrase of the language item repeated three times in the target language. The progression is automatic and does not require user action. Once all items have been introduced, Stage 1 is completed and the user is automatically advanced to Stage 2.

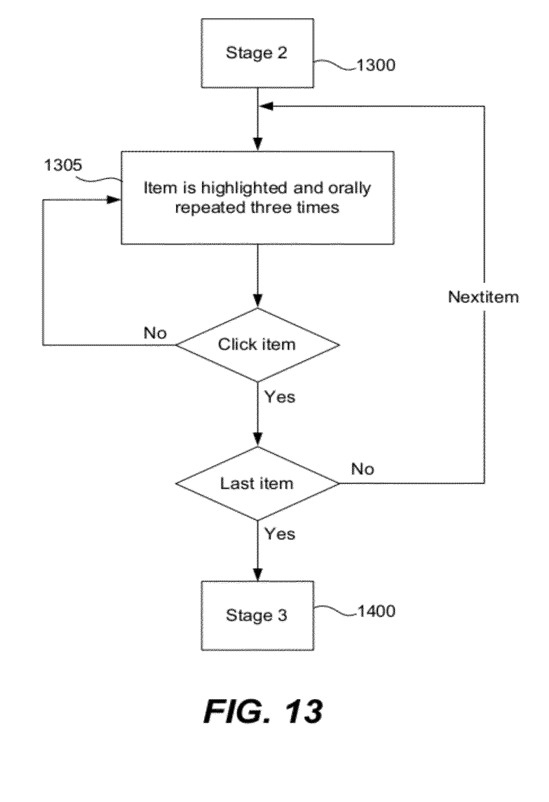

An overview of the process of Stage 2 is illustrated by the flowchart FIG. 13. Stage 2 is the Consolidation Stage 1300. In Stage 2, the items are presented sequentially with each item highlighted and repeated continuously until the user determines s/he has had enough input, whereupon the user clicks on the item visual. In step 1305, the system automatically highlights the next item, which is repeated continuously until the user determines s/he has had enough input and clicks on the item's visual. The process continues until all of the items have been consolidated. Once all items have been consolidated, Stage 2 is completed and the user is automatically advanced to Stage 3.

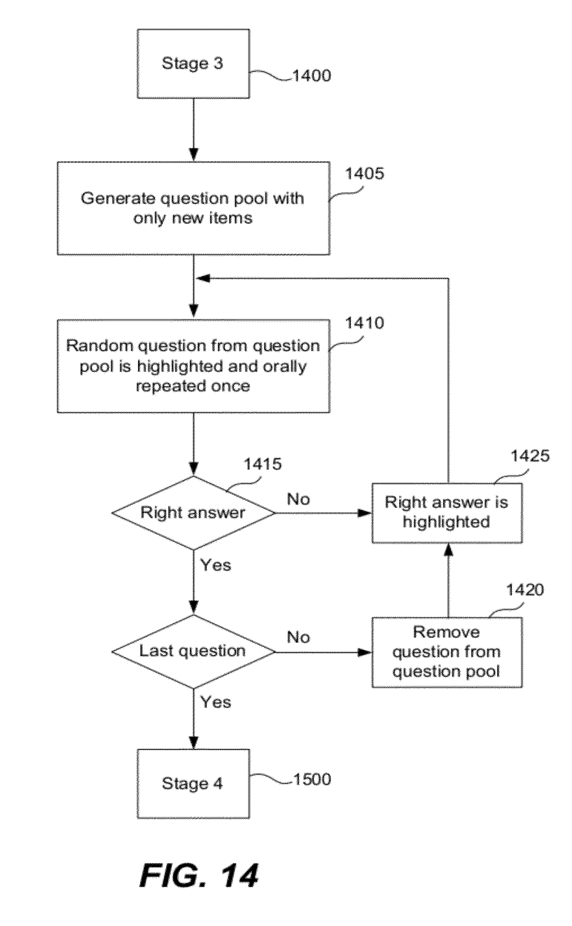

An overview of the process of Stage 3 is illustrated by the flowchart shown in FIG. 14. Stage 3 is the Expansion Stage 1400. In step 1405, a question pool is generated with new items. In step 1410, language items are presented in fixed order with a Question/Statement displayed above the items and randomly chosen from a Question/Statement pool. The Question/Statement is given a single audio presentation. The user clicks the item s/he believes to be correct. The score box on the screen is activated in Stage 3. If correct, the item is highlighted (step 1425), the answer acknowledged with a sound cue and one point is added to the Score Box. The question is removed from the Question/Statement pool in step 1420. If incorrect, the item is identified as incorrect with a sound cue and the correct answer is highlighted. The item identified incorrectly is recycled and given an audio presentation elsewhere in the activity until it is correctly identified. After a selection has been made and identified as correct or incorrect, the next item is given an audio presentation and the activity continues as above. The user must identify all new items in Stage 3 correctly. Once all new items have been identified correctly, Icon 114d is enabled. The user moves on to Stage 4 by clicking Icon 114d.

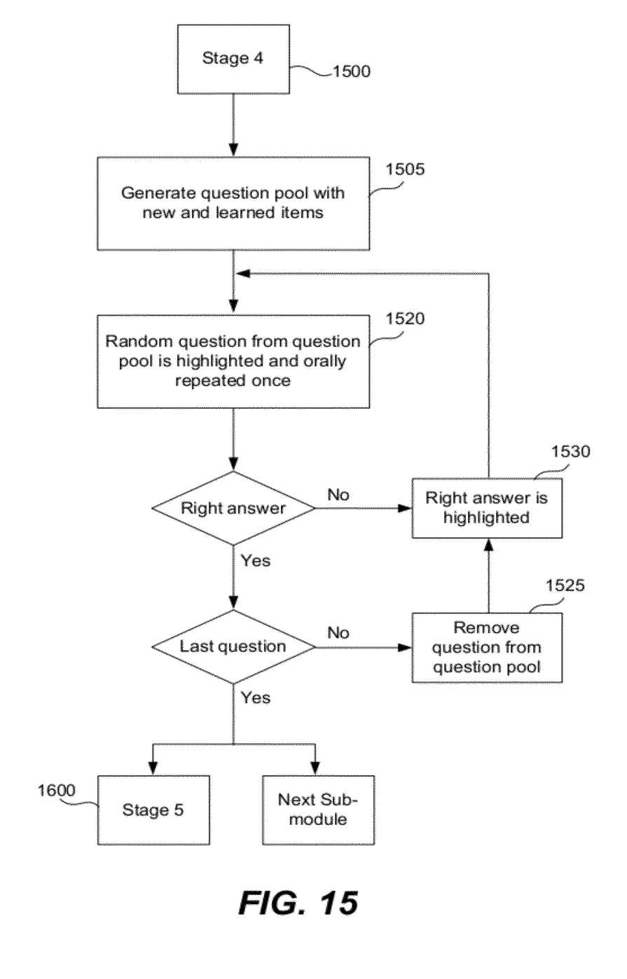

An overview of the process of Stage 4 is illustrated by the flowchart of FIG. 15. Stage 4 is the Education Stage 1500. In step 1505, a question pool is generated with new and learned items. All items from lower levels are recycled in Stage 4. In step 1505, language items are presented in random order with a Question/Statement displayed and randomly chosen from the Question/Statement pool. The Question/Statement is given a single audio presentation. The User clicks the item s/he believes to be correct. The Score Box on the screen is activated in Stage 4. If correct, the item is highlighted (step 1530), the answer acknowledged with a sound cue and one point is added to the Score Box. In step 1525, the Question/Statement is removed from the Question/Statement pool. If incorrect, the item is identified as incorrect with a sound cue and the correct answer is highlighted. The language item identified incorrectly is recycled back into the Question/Statement pool and may be given a subsequent presentation depending on the size of the Question/Statement pool. After a selection has been made and identified as correct or incorrect, the next item is given an audio presentation and the activity continues as above.

In the Education stage 1500, a rule is used to determine whether a user has learned the material with a sufficient degree of mastery to progress to the next stage. It is desirable in an education stage to require a high degree of accuracy but not perfect accuracy. In one embodiment, the user must correctly identify all of the items presented in Stage 4 (drawn from a pool of a maximum of 36 available items). Once the user has correctly identified all of the items (drawn from a pool of a maximum of 36 available items), Icon 114b is enabled. The user can choose from three options: click the final box in the Stage bar to move on to the optional “challenge” stage, review any previously studied stage by clicking on the appropriate box in the Stage bar, or move on to the next sub-module by clicking the “Next module” Icon 114b.

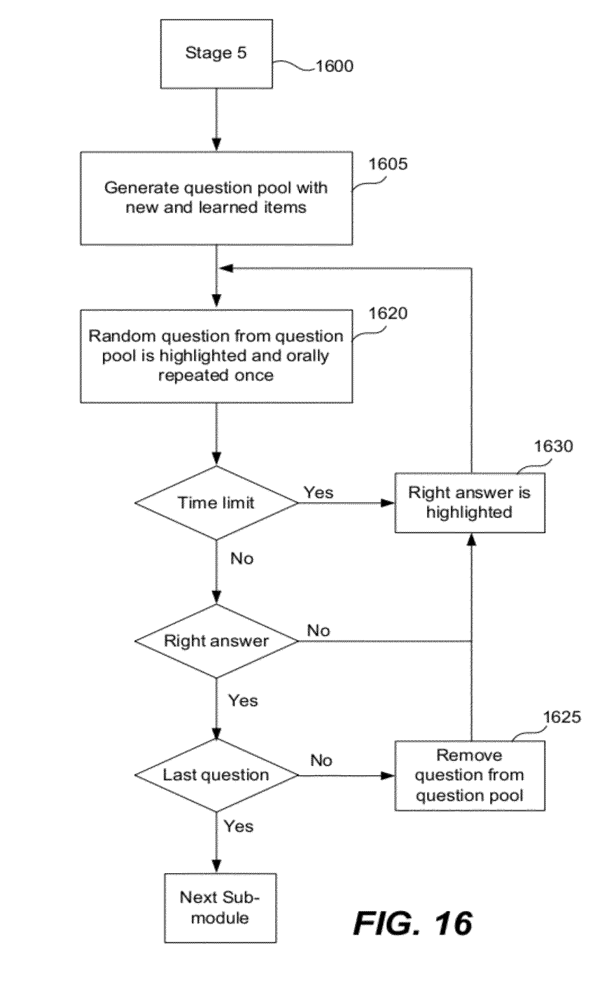

An overview of the process of Stage 5 is illustrated by the flowchart shown in FIG. 16. Stage 5 is the Challenge Stage 1600. Stage 5 is similar to Stage 4 with the exception of the addition of a time limit. Thus, Stage 5 also includes a step 1605 to generate a question pool of new and learned items, a step 1620 to present questions in random order, a step 1625 to remove correctly answered questions from the question pool, and a step 1630 to highlight correct answers. In one implementation, the user may also be required to correctly answer all of the questions in order to complete Stage 5. In an exemplary embodiment of Stage 5, the user is given an average of 3 seconds to select a language item and click a response. If the user can not select an answer in 3 seconds, the system automatically identifies this lack of a decision as an incorrect choice. Icon 114b is enabled from the outset of Stage 5.

When a sub-module is finished, the user can return to the sub-module to review it from the Course Learning Page FIG. 10.

### Learning Efficiency Considerations

One aspect of the present invention is the recognition by the inventors that optimal learning of a foreign language in a computer implemented technique requires features to promote the combination of focus, attention, and reward that optimizes learning of a foreign language in a short amount of learning time. One aspect of the present invention is a modular, spiralling curriculum format in which the training is repetitive and recycled at each new level. The content also grows increasingly complex over time in the spiralling format to create an intensive learning experience with the right amount of challenge for the user. Additionally, the modular, spiralling format results in frequent changes to topic, which combined with a very simple screen and user interface that provides improved user control, helps learners maintain a high level of concentration. These aspects of the spiralling format are believed to produce extremely efficient learning because they assist the brain to have the right level of stimulation (generating acetylcholine to help learners focus), stay in an attentive state (generating norepinephrine to call attention to errors, memorable words, etc. . . . ), and provide emotional satisfaction (the generation of dopamine which is released when a learner anticipated the reward of performing confidently in the target language). This approach helps the user achieve their language goals in a pleasant, rewarding format. A by-product of this format is the enhancement of memory retention due to constant recycling, incremental growth in manageable complexity, and intrinsic focusing of the user's attention. This enhancement of memory retention is particularly attractive for mature users.

The system of the present invention has been developed through extensive research to identify key features that work in an online environment to create an effective introduction to a foreign language. Classroom-based approaches, such as the ABLE technique developed by one of the inventors, permits a human teacher to teach students a crash course in a foreign language in as little as 12 to 15 hours. ABLE-based teaching techniques have small class sizes (e.g., 4-10 students) so that a teacher can intimately interact with students.

However, it is difficult to directly translate that experience into an online environment with anywhere near the same efficiency due to the many advantages that a human teacher has at monitoring the capabilities of their students and adapting their teaching style to the student. After significant experimentation and development, a beta version of an online language learning system permits users to reach similar proficiency as classroom-based ABLE in about 30 hours, or a little over twice the time as classroom-based implementation of ABLE. This is within the range of time that is acceptable for a crash introduction to a foreign language. More importantly, the Beta test results indicate that the online learning system of the present invention provides excellent results compared with other software-based language learning systems.

Many different factors appear to be required in combination to achieve a satisfactory user experience in an online environment. Preferably no more than six language items at a time are presented on the user interface. This is based upon research into memory. Presenting too many language items at one time reduces learning efficiency. A side benefit of limiting the number of language items is that it makes it easier to use a simple technique to receive user input, such as a point-and-click approach in which a user uses a mouse to point and click to select a language item (or its equivalent on a touch screen interface of tapping on a language item presented on the screen).

Beta testing indicates that there are an optimum number of language items that a user should be exposed to for efficient learning during a course. For example, if there are too many items, it hinders recycling of the language. The present invention provides users with an appropriate amount of content, thus optimizing the learning process. Moreover, the different learning modes and techniques used to generate “answer pool” and to remove items from these “answer pools” improve learner efficiency.

A beta test of an exemplary system has demonstrated rapid, efficient introduction of a target language in a time frame of approximately 30 hours of learning time. In an exemplary system there are up to six levels. Learners complete a module for a specific function at one level then proceed horizontally to the module for the next functional thematic area at the same level, Once a user completes all of the thematic modules at one level, they move on to the next level. This spiral progression results in frequent changes of topic (e.g., every 5-10 minutes) to help learners maintain a high degree of concentration throughout a lesson. The manner in which material is automatically recycled and expanded fosters retention. A suggested length of a learning session is 60 to 90 minutes. Thus, in a period of a few weeks a user can be introduced to a target language.

An exemplary system divides functional areas into five levels (Starter and Basic Courses) or six levels (Expanded Course) resulting in each thematic area's division into compartments containing sub-modules. Rather than progressing “vertically” through a single thematic area, learners complete the sub-module set for a specific function at one level, then proceed horizontally to the module for the next functional area at the same level (FIG. 3). Once all thematic sub-module sets at one level are completed, the learner proceeds to sub-module sets at the next level, where material is automatically recycled and expanded in a spiraling format (FIG. 4). By the end of the course, all functional areas have been touched on repeatedly and recently. Furthermore, important lexical categories (e.g. numbers) are recycled across functional areas within each level. All language has been reinforced and remains in the learner's memory, ready for immediate application. This recycling format incrementally enhances usage by learners.

Key explanations for the effectiveness of the online learning system is based on physiological processes which take place in the brain as we learn. The training is repetitive with the content of previous sub-module sets recycled at each new level. The content grows increasingly complex in a spiralling format, and the learning experience is intensive. The modular, spiralling format results in frequent changes of topic which, combined with a very simple screen and user interface, helps learners maintain a high level of concentration. These aspects combine to stimulate the brain, apparently by producing acetylcholine to help learners focus; norepinephrine to call attention to errors, memorable words, etc.; and dopamine, which is released when a learner anticipates and makes correct selections in the course sub-modules.

The user interface is preferably kept simple and easy to follow for an online implementation. The user interface is preferably easy to follow and preferably does not require auditory inputs from a user in the target language, particularly at the lower levels of the course. A simple user interface provides many advantages. First, a simple user interface makes it easier for users of different ages to easily use the user interface. For example, beta tests indicate that a simple interface helps older users feel comfortable with on-line learning. The simple user interface also facilitates adapting content and aural outputs based on age, gender, or other demographic factors, which also improves the learning experience. Secondly, a simple user interface is consistent with a variety of different interface speeds and is also compatible with the client device being a cell phone, such as a cell phone with a display.

As previously discussed, instruction is presented in the target language. However, some minimal assistance in the user language is included to facilitate learning, such as status information on the Progress Report. Another feature of the training system that assists rapid learning is the use of icons to contextually introduce key terms for “control” of conversation, including “What does that mean?”, “More slowly, please.”, “Once more, please.” and “How do you say this?” (shown in FIG. 11). The “control” language is presented as formulaic language which is intuitively learned by site users. The icons help, for example, to provide the user with a simple, intuitive means to control the conversation so that there is a sufficient amount of stimulation to foster learning without undue frustration. This is particularly important in the context of rapid introduction of a target language.

Traditional online and offline language training systems do not incorporate current brain research and “control” of conversation into their design as the present invention has. As a result, traditional systems are inefficient and less enjoyable for users due to their being grammar based and/or having words taught in isolation without a context or practical focus. Returning again to the traditional language training system of FIG. 2, in the prior art online/offline system, lessons are divided into thematic areas. For convenience, these thematic areas are typically taught as “stand alones” (e.g. 1. Street Directions, 2. Shopping, 3. Ordering in a Restaurant, etc.). For the majority of learners, this training system is relatively ineffective. Unless material is constantly and consciously recycled in the system, or reviewed on the learner's own initiative, previously studied topics and language are forgotten as the course progresses. The result is inefficient learning. Additionally, the traditional system does not provide an intuitive means to control the conversation.

In one implementation, the components are preferably designed to achieve a high learning efficiency. Also, the online learning system should have salience, in terms of satisfying learner-selected goals. Additionally there should be repetition at standard, regulated intervals in a spiralling format to promote rapid learning and retention.

### Conversation Management Features

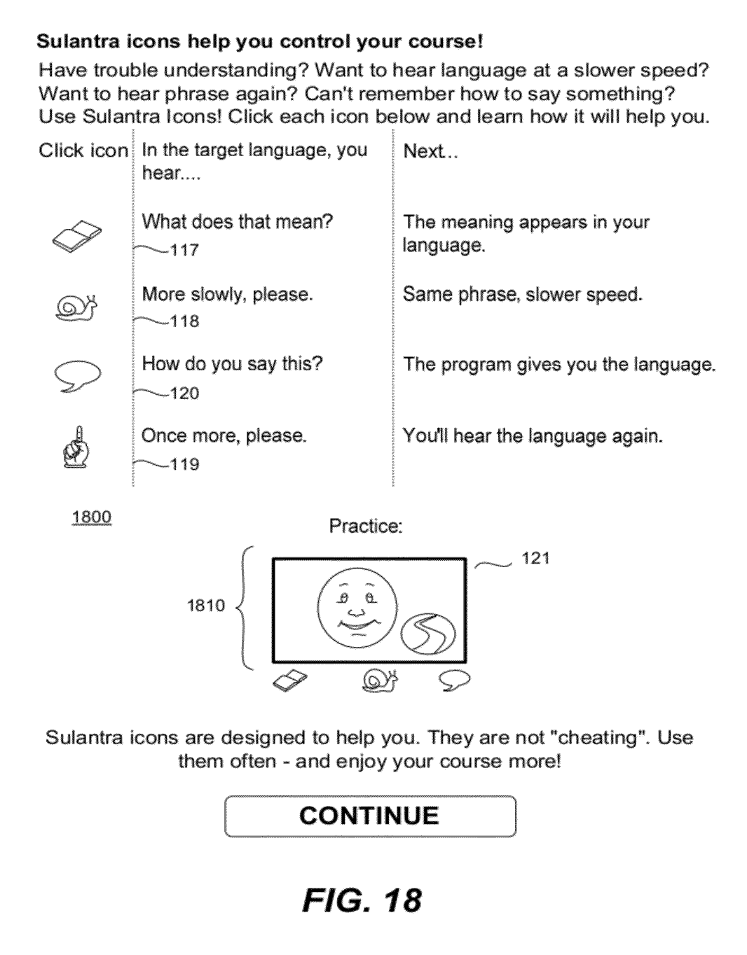

FIG. 18 is a screenshot explaining in more detail aspects of language assistance icons 117, 118, 119, and 120 used for conversation management. The conversation management page 1800 introduces the functions and includes a practice portion 1810. The language assistance icons have several aspects. When a language assistance icon is clicked, an entire conversation management phrase is heard in the target language. Exemplary conversation management phrases are “What does that mean?”; “More slowly, please”; “How do you say this?” and “Once more please.” Thus, the user quickly develops an association in which they learn the conversation management phrase in its entirety in the target language. This is extremely useful in later use of the target language as the user learns to remember the precise phrases that they will need in real life to get people to speak slower, repeat things, and ask basic questions about what words mean and how to say things.

Moreover, the language assistance icons are extremely useful in the learning process, because they provide an additional means for the user to customize the course for their individual needs. For example, icon 118 permits a user to slow down the audio for only those specific language ideographs that the user has trouble following the pronunciation. Icon 119 permits a user to repeat the audio for only those specific language items that the user has trouble with. An individual language item 121 may represent more complex words or phrases, particularly at higher levels. This raises the possibility that some users might have trouble immediately understanding the meaning of language items without assistance. Thus, icon 117 provides a means for a user to confirm the meaning of an individual language item 121 as needed by the user. Icon 120 provides a means for a user to remember a word or phrase that they can't remember.

Consider an example where the target language is Chinese and the user language is English. When icon 117 is clicked, the next action is that the meaning of the language item 121 appears in the user language. If the target language is Chinese and the user language is English, then pressing icon 117 results first in the user hearing, in Chinese, the entire phrase “What does that mean?.” Then the user would learn the meaning of the phrase associated with the language item in English, such as through a text block. Continuing with this example, if icon 118 is pressed, the user would hear, in Chinese, the phrase “More slowly please.” Then the same phrase associated with the language item would be presented, except at a slower speed, such as 75% normal speed. If icon 119 is clicked, then the user would hear in Chinese the phrase, “Once more please.” Then the audio for the language item would be repeated in the target language (Chinese). If icon 120 is clicked, then the user hears in Chinese the phrase “How do you say this?” followed by the language pertaining to that visual in Chinese.

The language assistance icons 117, 118, 119, and 120 provide important learning benefits and improve the efficiency of the learning process. Yet surprisingly, conventional language learning software techniques do not include these features. The benefits of language assistance icons 117, 118, 119, and 120 comes at only marginal additional costs in terms of additional computing resources and database storage to implement these functions. For example, software to slow down the audio component without compromising sound quality is commercially available and can be used to provide a slower audio version of the target word or phrase pursuant to the function of icon 118. Icon 117 can be implemented using database techniques to link a language item to a translation in the user language. Icon 119 can be implemented as a simple command to repeat the audio for a language item. Icon 120 can be implemented as a simple command to elicit the audio for a specific item.

### Spiral Learning Progression Table Examples

As previously discussed, the curriculum may be presented in a spiraling format in which the curriculum has a set of different thematic functions and the course recycles content at each level in a progression. As one example, consider a number, such as the number “8.” This number can be introduced at a lower level and then presented as part of larger phrases in different functions (meeting people, shopping, directions, etc.). As one example, the number eight can be recycled and expressed as part of larger phrases such as “$80, “268 Chinese Yuan,” “At 8:00 next Sunday,” “At gate 8”, “Bus number 18” “the lunch costs 28 Yuan.”

One way to implement this spiral curriculum is map the progress of the curriculum using progression tables to represent a progression of language items at different levels and for different thematic functions. The progression, in turn, can be used to formulate database rules for the spiral format curriculum control engine 1750 of FIG. 17.

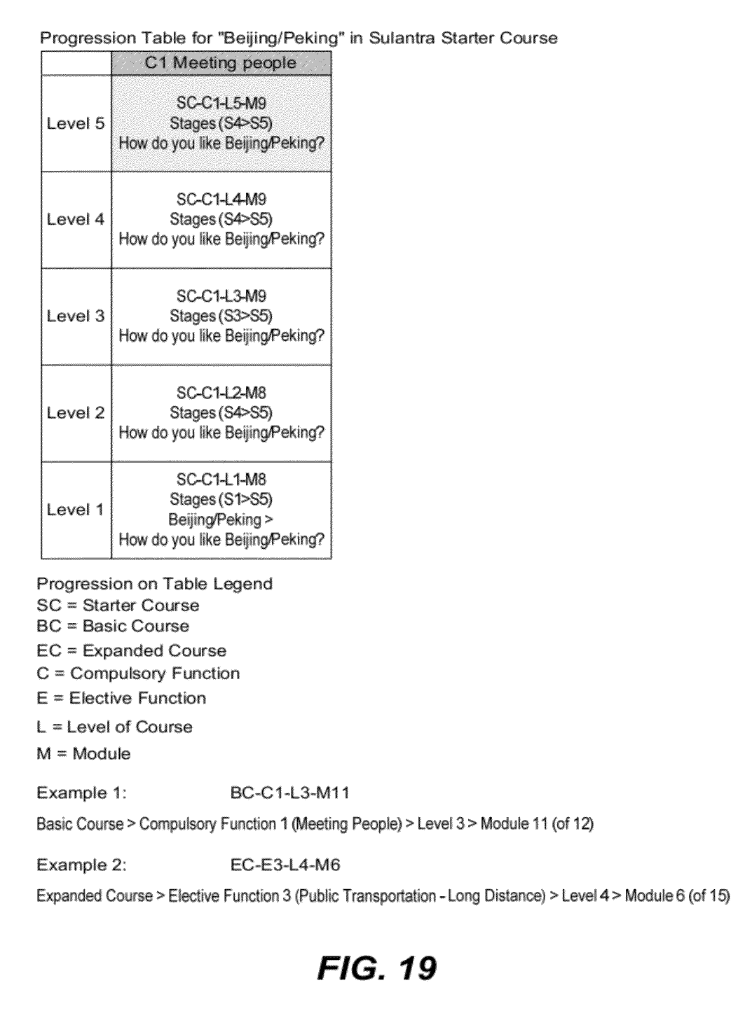

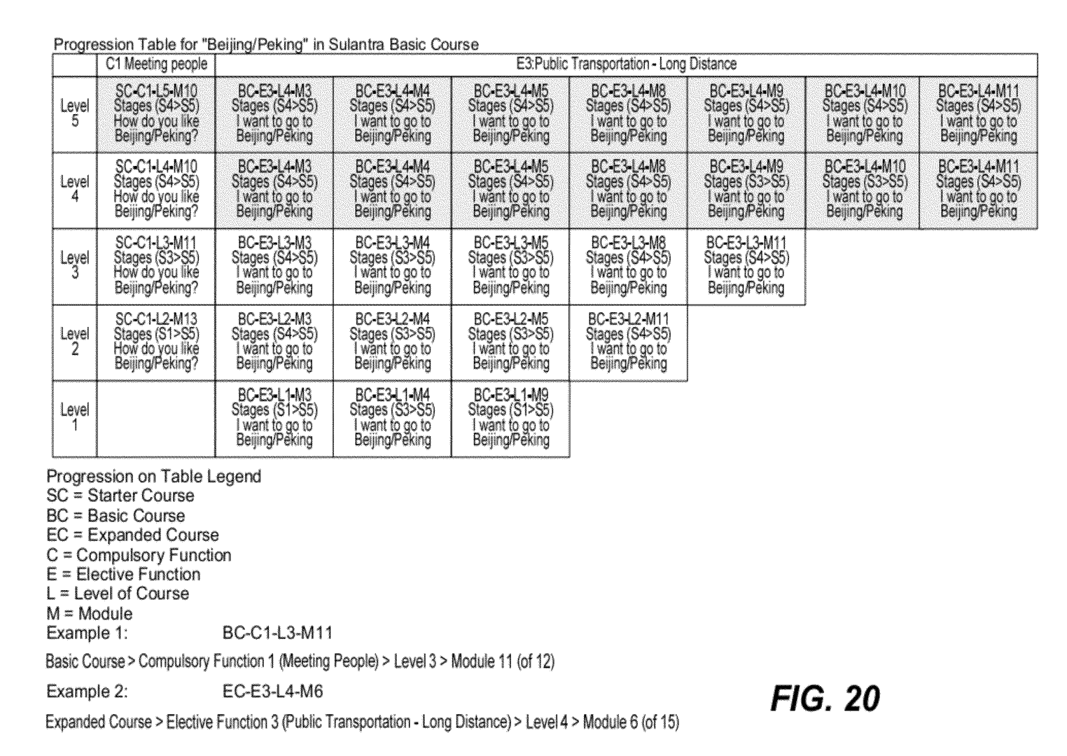

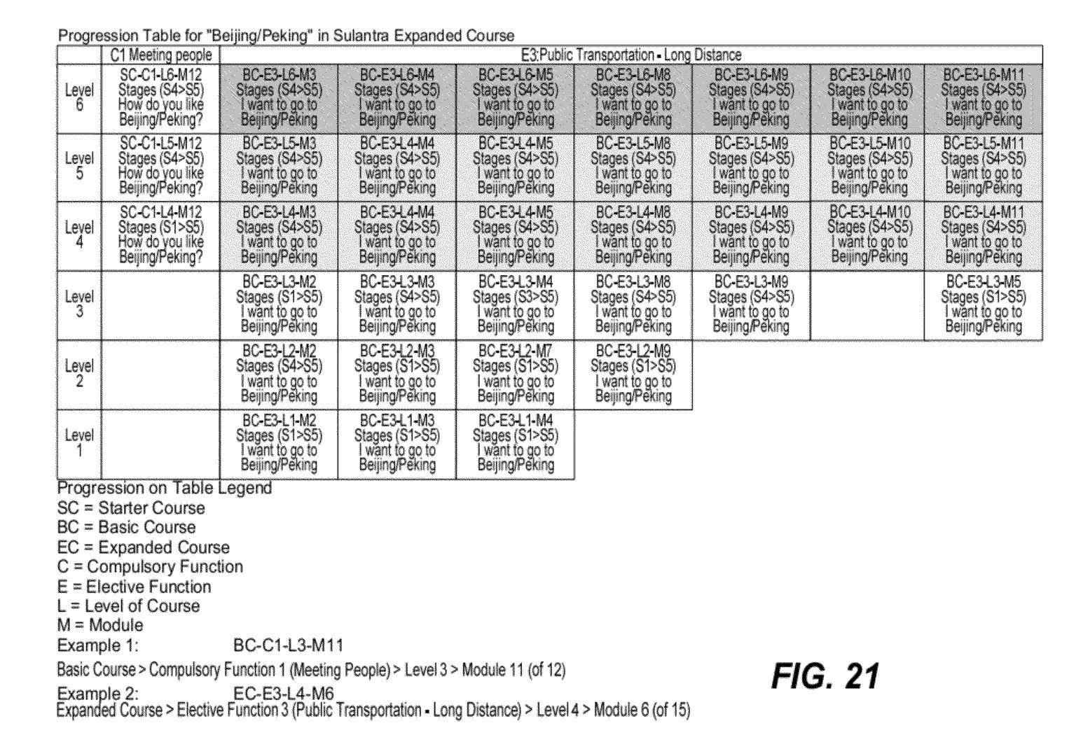

FIGS. 19-21 illustrate different aspects of progression. FIG. 19 is for a starter course, FIG. 20 for a basic course, and FIG. 21 is for an expanded course. These examples illustrate a progression at different levels for the word “Beijing,” (the capital of mainland China, sometimes still referred to as Peking in older travel guidebooks). The word “Beijing” is introduced at lower levels alone and in specific phrases (depending on the thematic function). The phrases are recycled at higher levels and also used in different and/or more complex phrases for some of the higher levels. This is illustrated in FIGS. 20-21 in which “Beijing” appears in new phrases as the user advances past level 1. Additionally, FIGS. 19-21 illustrate repetition at higher levels. In this example, the phrase “How do you like Beijing” is introduced at lower levels and also repeated for reinforcement.

While FIGS. 19-21 illustrate one example of progression tables more generally it will be understood that an individual of ordinary skill in the art could implement progression tables for large numbers of language items 121. The progression tables can, in turn, be converted into rules for a spiral progression to recycle previously learned content and also present the old content in new applications as the user advances through the curriculum.

Note that the progression tables can represent the progression of content in either more complex language items (more complex individual ideographs, such as ideographs including both numbers and pictures), in more complex thematic contexts (e.g., a portion of the meaning of a language item arising from its use within a thematic function), or in a more complex manner in terms of associations between different language items (i.e., two or more ideographs to represent a phrase).

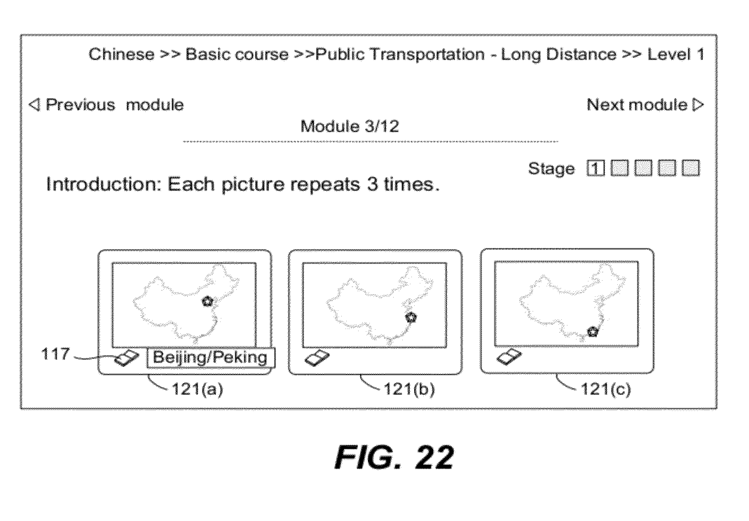

FIG. 22 is an example screen shot showing an introductory learning phase in which the user learns the word “Beijing.” In this example, the three language items 121 include a map of mainland China and the locations of different major cities. One of the language items 121(a) correctly represents the location of Beijing while the other language items represent other cities. The user learns the association between the geographic location of Beijing (left-most language item 121) and the Chinese word (i.e., “Beijing” spoken three times for the left-most language ideograph).

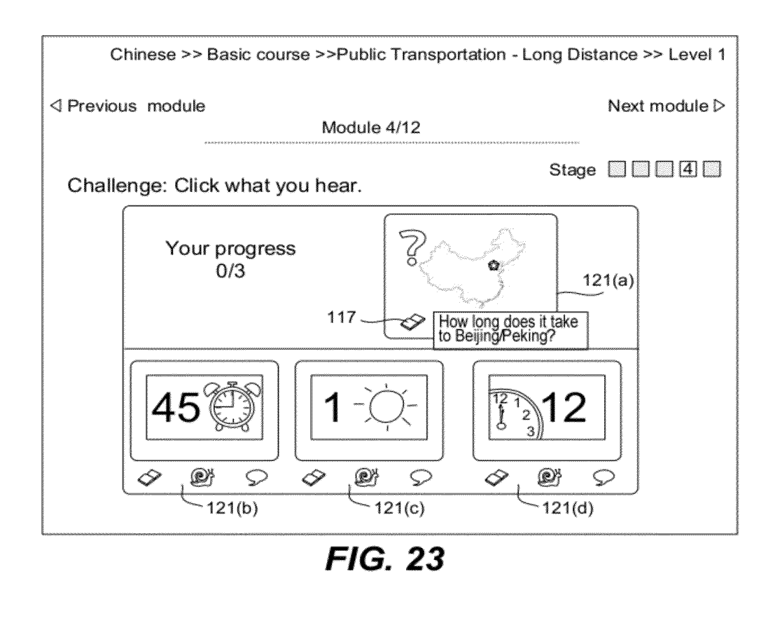

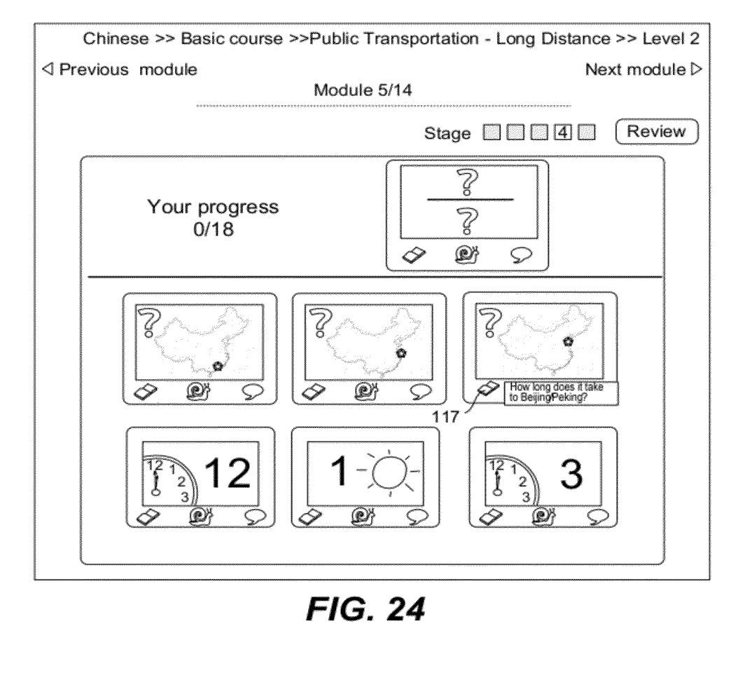

More complex phrases can be taught by contextualization. One aspect is that the contextualization can occur as a word is included in a larger phrase in a particular thematic function. In the examples of FIGS. 23-24, “Beijing” is embedded in a larger question, such as “How long does it take to Beijing” (top language item of FIG. 23). Additional language items are presented in a bottom row of FIG. 23 as responses to the question. In this example, the user is prompted for a response. The bottom left language ideograph illustrates a clock and numbers to illustrate a number of minutes. The middle language ideograph has a number and a symbol of a sun to illustrate days and the right-most language ideograph has a number and a wall clock to illustrate hours.

Additionally, note that other types of associations between two different language items are possible. FIG. 24 illustrates a double-response format in which the top row of language items represents a previously studied question and the bottom row of language items represents previously learned responses. It can be seen in these examples that different combinations of language items can be presented to represent associations of concepts, with question/response being one type of association. More generally, however, other types of associations are possible, such as representing larger phrases using two or more different language items

Referring back to the example of FIG. 23, the use of the language assistance icons is also illustrated. The user can click on assistance icon 117 to learn the meaning of the question “How long does it take to Beijing?” Similarly, in FIG. 24 the use of the language assistance icon is illustrated.

### Alternate Embodiments and Implementations

An exemplary system was described to provide online language services, such as through a user's computer or cell phone. Such a service may be provided as a free service by hosting advertisements on the web-site or by a subscription model. Additionally, it will be understood that the service may be implemented as a computer software product sold to individuals, companies, or government organizations.

It will be understood that variations on the manner in which a user inputs selections are contemplated. For a cell phone implementation selections may be made via tapping on a touch screen; alternatively a simple key stroke (e.g., inputting the numerals 1, 2, 3, 4, 5, or 6) to select from the language items that are displayed. Simple voice commands (e.g., 1, 2, 3 . . . ) may also be used on phones having speech-to-text recognition.

Additional optimizations include different types of course complexity based on user interest. In one implementation, there is an abbreviated starter course designed to be learned in 10 to 15 hours. This permits the starter course to be learned in about ten days, assuming learning sessions no more than 90 minutes per day. The abbreviated starter course, may for example, have a limited number of functional areas. A user may then go on to study a Basic or Expanded course with more hours of study time.

As previously discussed, in one implementation the user is not required to speak in the target language as part of the learning process. However, while this aspect is useful for providing instruction in the lower levels of a course, it will be understood that in an alternate implementation that the user may input responses in the target language in, for example, higher level courses. Requiring the user to input responses in the target language has the disadvantage of requiring the user to have a microphone and be in an environment where they can input words and phrases in the target language. Additionally, language recognition software, in the target language, is also required. However, this feature may be included as an option for some advanced levels or courses.

It is will also be understood that many functional equivalents are contemplated. For example, it is currently contemplated that the system will be provided from one or more central servers as an interactive service with client devices. However, connections to the Internet are not always available in some portions of the world. Moreover, cell phone coverage is not available in all locations and cell phones must be turned off in some situations, such as travelling on airplanes. It will therefore also be understood that an alternate embodiment would be for an online service to generate a customized curriculum in a target language for a user and then for the user to download the customized curriculum for later use on a personal device, such as on a cell phone, portable computer, or other portable device. In this alternative implementation, a user would also download a version of client software to run the customized curriculum on a user device, such as on a portable computer or cell phone having a local memory capable of storing downloaded software and data for a customized curriculum.

While the invention has been described with regard to detailed processes and user interfaces to provide the service to client devices, it will also be understood that it is contemplated that the processes and modules described above may be stored on a non-transitory computer readable storage medium and the computer readable storage medium used by different entities. For example, a large corporation or government may desire to run the system on their own servers for use by their employees. Thus, it will be understood that the service may also be implemented as a computer readable medium product. Although the above has generally described the present invention according to specific processes and apparatus, the present invention has a much broader range of applicability. In particular, aspects of the present invention are not limited to course learning and creation of course functions, and other applications which have not been identified at this time may become apparent in the future.

1. A computer-implemented method of providing an introduction to any language within a matrix of foreign languages from a language provider site, comprising:
receiving at a client device a request for an input from a user to provide to the language provider site an indication of a selection of a target language and a user language from a matrix of different target languages and user languages; and
receiving, at the client device of the user, language instruction in the selected target language, the language instruction being presented in a limited curriculum presented in a spiraling format in which the limited curriculum has a set of different thematic functions organized in a series of levels of increasing complexity, the spiral format arranged so that at each level a user progresses through each member of the set of different thematic functions before progressing to a more complex level.

2. The computer-implemented method of claim 1, further comprising: providing a user interface for the user to tailor the limited curriculum for relevance based on at least one of course complexity and optional thematic functions within the limited curriculum; and providing language instruction in the spiraling format based on a tailored limited curriculum.

3. The computer-implemented method of claim 1, wherein there are at least two different versions of the limited curriculum, the method further comprising: receiving information on a demographic group associated with the user and in response providing a version of the curriculum presented to the user based on the demographic group associated with the user.

4. The computer-implemented method of claim 3, wherein the demographic group includes at least one of age and gender.

5. The computer-implemented method of claim 1, wherein a user interface presents language instruction by presenting graphical images and sounds on a user interface and receiving user inputs to select an individual graphical image via at least one of a point-and-click interface and a touch screen interface.

6. The computer-implemented method of claim 5, wherein the user interface presents language instruction at each level using a set of six language items maximum for the user to choose from, where each language item is a graphical ideograph representing a word or phrase of a thematic function with each language item having associated with it at least one audio segment in the target language for training and testing.

7. The computer-implemented method of claim 6, wherein the user interface further includes at least one conversation management assistance icon.

8. The computer-implemented method of claim 6, wherein during an introductory stage a language item is highlighted and the corresponding audio segment for the language item is activated.

9. The computer-implemented method of claim 6, wherein during a consolidation phase, an item in the set of items is highlighted and the corresponding audio segment is played until the user clicks the highlighted item.

10. The computer-implemented method of claim 6, wherein during an expansion phase items in a set of items are displayed in a fixed order, a question pool of audio segments in the target language is generated, and a user clicks on an item that the user believes matches an audio segment.

11. The computer-implemented method of claim 6, wherein during a random question pool phase, a set of items is displayed and a question pool of audio segments in the target language is presented in a random order and a user clicks on an item that the user believes matches an audio segment.

12. The computer-implemented method of claim 6, wherein each language item further comprises at least one learning assistance icon for the user to request assistance with the language item.

13. The computer-implemented method of claim 6, wherein the set of language items includes no more than six language items that are displayed at a particular time.

14. A computer-implemented method of providing an introduction to a foreign language from a language learning site, comprising:
providing, at a client device, foreign language instruction of a target language in a limited curriculum presented in a spiraling format in which the limited curriculum has a set of different thematic functions organized in a series of levels of increasing complexity, the spiral format arranged so that at each level a user progresses through each member of the set of different thematic functions before progressing to a more complex level;
the foreign language instruction being presented via a user interface in which the user interface presents a maximum number of language items at any one time, each language item being an ideograph representing a unit of a thematic function and having associated with it at least one audio segment in the target language for introducing the language items and testing knowledge of the language item, the user interface receiving inputs during a learning session indicating a selection of an individual language item.

15. The computer-implemented method of claim 14, wherein the limited curriculum is selected from a set of different versions of limited curriculum for the target language based on at least one input received from the user indicative of a demographic group of the user, whereby the limited curriculum presented to an individual user is adjusted to be relevant to the demographic group of the individual user.

16. The computer-implemented method of claim 15, wherein for at least one target language the limited curriculum is selected based at least in part on an input from the user indicative of the gender of the user.

17. The computer-implemented method of claim 14, wherein the limited curriculum is selected from a set of different versions of the limited curriculum based on an input from the user indicative of the age of the user.

18. The computer-implemented method of claim 14, wherein the limited curriculum is selected from a set of different versions of the limited curriculum of limited curriculum for the target language based on at least one input received from the user indicative of an option related to the length of the course.

19. The computer-implemented method of claim 18, wherein the option corresponds to at least a basic course and an expanded course.

20. The computer-implemented method of claim 14, wherein the limited curriculum includes a set of mandatory thematic functions and also a set of optional thematic functions for the Basic and Expanded versions of the course, the user indicating a selection of optional thematic functions.

21. A computer-implemented method of providing an introduction to a matrix of foreign languages from a language provider site, comprising:
receiving at the foreign language provider site, user information including an indication of the age of a user, the gender of the user, a selection of a target language and a user language from a matrix of different target languages and user languages, a selection of a basic course or an advanced course, and a selection of optional thematic language functions to be included with mandatory thematic language functions to form a set of thematic language functions;
in response to the user information for the Basic and Expanded version of the course, selecting a limited curriculum for the user from a larger set of different versions of limited curriculum, wherein the limited curriculum is customized for the user based on the user's selections;
providing, at a client device of the user, language instruction in the selected target language, the language instruction being presented in the limited curriculum presented in a spiraling format in which the limited curriculum has the set of different thematic functions organized in a series of a set of levels of increasing complexity, the spiral format arranged so that at each level the user progresses through each member of the set of different thematic functions before progressing to a more complex presentation of the set of thematic functions at the next level;
the foreign language instruction being presented at the client device via a user interface in which the user interface presents a maximum number of language items at any one time for testing or learning, each language item being an ideograph representing a unit of a thematic function and having associated with it at least one audio segment in the target language, the user interface receiving inputs during a learning session by a selection of an individual language item;
wherein the selection versions of language items presented on the user interface is based on the limited curriculum customized for the user based on the user's selections.

22. The computer-implemented method of claim 21, wherein a maximum of six language items are presented at one time on the user interface.

23. The computer-implemented method of claim 22, further comprising:
providing a conversation management assistance icon in the user interface.
